(19) United States
(12) Patent Application Publication
(10) Pub. No.: US 2016/0131323 A1
(43) Pub. Date: May 12, 2016

(54) Vehicle Lamp

(71) Applicant: SL Corporation, Daegu (KR)

(72) Inventors: Sung Wook Youn, Gyeonsangbuk-Do (KR); Jin Young Park, Gyeonsangbuk-Do (KR); Hyo Jin Han, Gyeonsangbuk-Do (KR)

(21) Appl. No.: 14/867,403

(22) Filed: Sep. 28, 2015

(30) Foreign Application Priority Data
Nov. 7, 2014 (KR) 10-2014-0154682

(51) Int. Cl. F21S 8/10

(52) U.S. Cl. CPC F21S 48/24; F21S 48/328; F21S 48/1317; F21S 48/1283

(57) ABSTRACT

A vehicle lamp is provided. The vehicle lamp includes a lens having an aspherical surface positioned on an optical axis extending along a lengthwise direction of a vehicle and a flange coupled to a rear portion of the aspherical surface. The vehicle lamp further includes a first light source positioned behind a focus of the aspherical surface, a reflector which reflects light of the first light source toward the aspherical surface and a second light source which generates laser light toward the flange. A reflective member is positioned on the flange and forms an optical image by reflecting the laser light such that the laser light travels along a defined path.

### CROSS-REFERENCE TO RELATED APPLICATION

This application claims priority from Korean Patent Application No. 10-2014-0154682 filed on Nov. 7, 2014, the disclosure of which is incorporated herein by reference in its entirety.

### TECHNICAL FIELD

The present invention relates to a vehicle lamp, and more particularly, to a vehicle lamp which can form a particular image using laser light.

### RELATED ART

Generally, a vehicle is equipped with various vehicle lamps having a lighting function and a signaling function. In other words, the vehicle lamps enable the driver of the vehicle to detect objects surrounding the vehicle while driving during low light conditions and inform other vehicles and road users of the vehicle's intended driving state.

For example, the vehicle lamps may include lamps that directly emit light, such as a headlamp to illuminate the road ahead to enhance the driver's field of view, a brake light that is engaged when the brakes are applied, and a direction indicator that is used to signal other vehicles of the vehicles intention to turn right or left. Additionally, a reflector may be positioned on the front and rear sides of the vehicle to reflect light such that the vehicle may be recognized by approaching vehicles. Specification and installation standards for vehicle lamps are regulated by law to ensure the vehicle lamps to perform their functions.

Generally, vehicle lamps use a light-emitting diode (LED) or a laser diode as a light source. Currently, research is being conducted to utilize light generated by exciting a phosphor using light emitted from a light source as an excitation light. In this case, laser light emitted from the laser diode may be collected without a loss attributed to its intense luminescence and strong directivity. Therefore, the laser diode may produce clearer light with a greater luminance than the LED. Recently, the functionality of the lamp module has extended beyond performing lighting functions and signaling functions. The lamp module can provide improve visibility and spatial awareness about a particular manufacturer's product by emitting a particular form of light. However, varying the form of emitted light, does not easily distinguish a product from other products using this technology. Therefore, it is necessary to introduce a vehicle lamp that can clearly distinguish a vehicle from other vehicles.

### SUMMARY

An aspect of the present invention provides a vehicle lamp which can form an optical image distinguished from those of other vehicles using laser light.

According to an aspect of the present invention, an exemplary embodiment provides a vehicle lamp that may include a lens having an aspherical surface positioned on an optical axis that may extend along a lengthwise direction of a vehicle. The exemplary embodiment may further include a flange integrally coupled to the rear of the aspherical surface and a first light source that may be positioned behind a focus of the aspherical surface. The vehicle lamp may further include a reflector that may reflect light of the first light source toward the aspherical surface and a second light source which may generate laser light in the direction of the flange. A reflective member may be positioned on the flange and may form an optical image by reflecting the laser light such that the laser light may travel along a predetermined path.

The second light source may be positioned on a side of the flange and may irradiate the laser light toward the flange in a direction perpendicular to the optical axis. In some embodiments, the reflective member may be formed by coating or depositing a reflective material. In other embodiments, the reflective member may be formed on the entre circumferential surface of the flange, and the predetermined path along which the laser light travels may vary according to an angle at which the laser light may be incident from the second light source onto the flange. Still in other embodiments, the reflective member may reflect the laser light that travels along the predetermined path, out of the lens.

In other embodiments the vehicle lamp may include a light-blocking member having a pattern that may scatter (e.g. disperse) the laser light that may be reflected out of the lens. In some embodiments, the reflective member may include a plurality of reflective regions having a predetermined reflectivity. The reflective member may include a plurality of reflective regions having the same reflectivity such that illuminance of reflected laser light may be reduced at a constant rate according to the number of reflections. The reflective member may reflect the laser light such that the predetermined path may form an infinite loop.

In another embodiment, the optical image may have a polygonal shape or an overlap of polygonal shapes. In some embodiments, the flange may form a positioning beam pattern through the optical image. The vehicle lamp may further include a heat sink that may be coupled to the second light source and may dissipate (e.g. absorb or thereby reduced) the heat generated by the second light source.

According to another aspect of the present invention, a vehicle lamp may include a lens which may include an aspherical surface positioned (e.g., disposed) on an optical axis extending along a lengthwise direction of a vehicle and a flange that may be integrally coupled to the rear (e.g. rear portion) of the aspherical surface. The vehicle lamp may further include a first light source that may be positioned behind a focus (e.g., focus point) of the aspherical surface and a reflector which may reflect light of the first light source toward the aspherical surface. The vehicle lamp may further include a second light source which may generate laser light and a lens holder that may include an incident region upon which the laser light may be incident and may be coupled to the flange so as to fix the lens. A reflective member may be located on the interior of the lens holder which may meet (e.g., be coupled to) the flange and may form an optical image by reflecting the incident laser light such that the laser light may travel along a predetermined path on the flange.

In some embodiments, the second light source may be positioned on a side of the incident region and may irradiate the laser light toward the incident region in a direction perpendicular to the optical axis. In other embodiments, the reflective member may be formed by coating or depositing a reflective material. The reflective member may be formed on the entre interior of the lens holder which may be coupled to the flange (e.g., meets the flange). In some embodiments the predetermined path along which the laser light travels may vary according to an angle at which the laser light may be incident from the second light source onto the incident region.

In other embodiments, the reflective member may reflect the laser light, which may travel along the predetermined path, out of the lens. The vehicle lamp may further include a light-blocking member that includes a pattern which may disperse (e.g., scatters) the laser light reflected out of the lens. The reflective member may comprise a plurality of reflective regions having the same reflectivity such that illuminance of reflected laser light may be reduced at a constant rate according to the number of reflections. In some embodiments, the optical image may have a polygonal shape or an overlap of polygonal shapes.

### BRIEF DESCRIPTION OF THE DRAWINGS

The above and other aspects and features of the present disclosure will become more apparent inform the following detail description taken in conjunction with the accompanying drawings:

FIG. 1 is an exemplary a view illustrating a vehicle equipped with any one of vehicle lamps according to an exemplary embodiment of the present invention;

FIG. 2 is an exemplary perspective view of a vehicle lamp according to an exemplary embodiment of the present invention;

FIG. 3 is an exemplary lateral view of the vehicle lamp of FIG. 2;

FIG. 4 is an exemplary illustration of a case where laser light emitted from the vehicle lamp of FIG. 2 passes through a medium;

FIG. 5 is an exemplary front view of the vehicle lamp of FIG. 2;

FIG. 6 is an exemplary front view of the vehicle lamp of FIG. 2;

FIG. 7 is an exemplary front view of the vehicle lamp of FIG. 2;

FIG. 8 is an exemplary front view of the vehicle lamp of FIG. 2;

FIG. 9 is an exemplary schematic view of a light-blocking member according to an embodiment of the present invention;

FIG. 10 is an exemplary schematic view of a second light source and a heat sink according to an exemplary embodiment of the present invention;

FIG. 11 is an exemplary front view of the vehicle lamp of FIG. 2;

FIG. 12 is an exemplary front view of the vehicle lamp of FIG. 2;

FIG. 13 is an exemplary perspective view of a vehicle lamp according to another exemplary embodiment of the present invention;

FIG. 14 is an exemplary perspective view of a second light source, a lens holder, and a reflective member according to another exemplary embodiment of the present invention;

FIG. 15 is an exemplary lateral view of the vehicle lamp of FIG. 13;

FIG. 16 is an exemplary front view of the vehicle lamp of FIG. 13;

FIG. 17 is an exemplary perspective view of the vehicle lamp of FIG. 13;

FIG. 18 is an exemplary schematic view of a light-blocking member according to another exemplary embodiment of the present invention; and

FIG. 19 is an exemplary front view of the vehicle lamp of FIG. 13; and

FIG. 20 is an exemplary front view of the vehicle lamp of FIG. 13.

### DETAILED DESCRIPTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated components, steps and/or operations but do not preclude the presence or addition of one or more other components, steps and/or operations. As used herein, the term “and/or” includes any and all combinations of one or more of the associated listed items. For example, in order to make the description of the present invention clear, unrelated parts are not shown and, the thicknesses of layers and regions are exaggerated for clarity. Further, when it is stated that a layer is “on” another layer or substrate, the layer may be directly on another layer or substrate or a third layer may be disposed therebetween.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

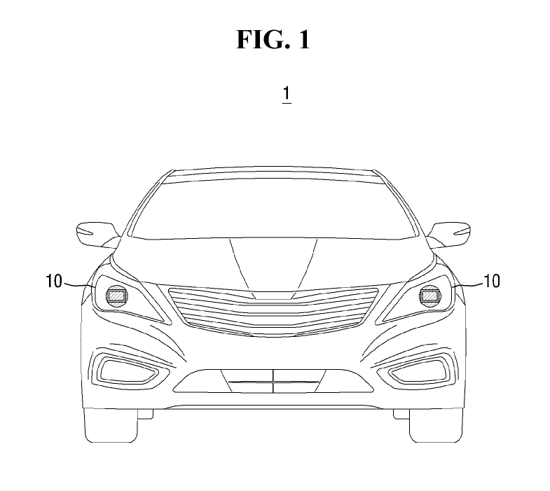

As shown in FIG. 1 a vehicle may be equipped with any one of vehicle lamps 10 and 20 according to exemplary embodiments of the present invention. Referring to FIG. 1, each of the vehicle lamps 10 and 20 according to the exemplary embodiments may be a headlamp that may form a beam pattern such as a high beam pattern or a low beam pattern. However, each of the vehicle lamps 10 and 20 are limited to the headlamp and may also be any one of various lamps that may be included in a vehicle. Typically, lamps included in a vehicle may include, but are not limited to, a tail lamp, a brake lamp, a backup lamp, a turn signal lamp or a position lamp.

In the present exemplary embodiment, each of the vehicle lamps 10 and 20 may be a lamp positioned on a left or right side of a vehicle. Therefore, it may be understood that a vehicle lamp (not described herein) positioned on the opposite side of the vehicle may have the same configuration as the vehicle lamp 10 or 20 of the exemplary embodiment or may be horizontally symmetrical to the vehicle lamp 10 or 20 of the exemplary embodiment.

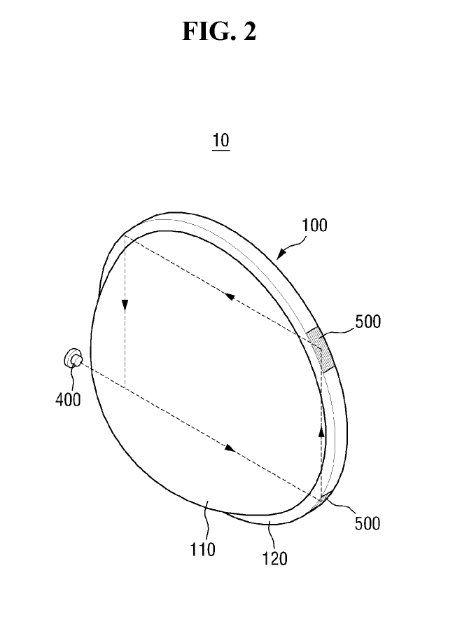

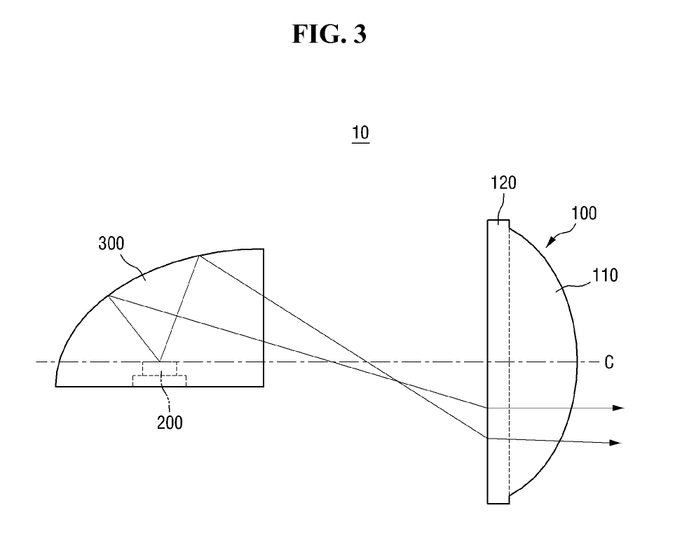

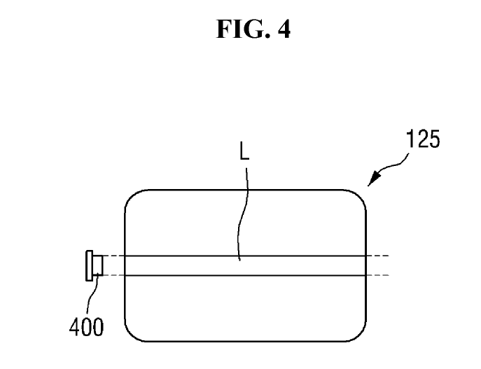

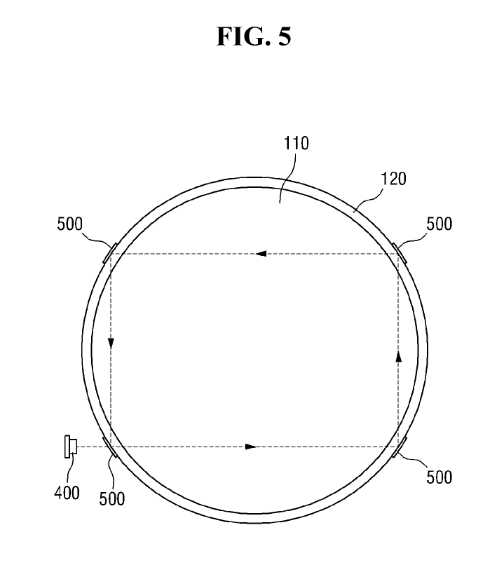

FIG. 2 is an exemplary perspective view of a vehicle lamp 10 according to an exemplary embodiment of the present invention. FIG. 3 is an exemplary lateral view of the vehicle lamp 10 of FIG. 2. Additionally, FIG. 4 is an exemplary illustration of a case where laser light that may be emitted from the vehicle lamp 10 of FIG. 2 may pass through a medium. Further, FIGS. 5 through 7 are exemplary front views of the vehicle lamp 10 of FIG. 2.

Referring to FIGS. 2 and 3, the vehicle lamp 10 of the exemplary embodiment may include a lens 100, a first light source 200, a reflector 300, a second light source 400 and a reflective member 500 but does not preclude the addition of other components. The lens 100 may include an aspherical surface 110 which may be positioned on an optical axis C extending along a lengthwise (e.g., lateral) direction of a vehicle and a flange 120 that may be integrally coupled (E.g., connected to) to the rear portion of the aspherical surface 110. The aspherical surface 110 may project light that may be irradiated from the first light source 200 toward the front portion of the vehicle or light that may be irradiated from the first light source 200 and then reflected toward the front portion of the vehicle by the reflector 300.

In the exemplary embodiment, light transmitted through the aspherical surface 110 may be distributed out of the vehicle to forma low beam (e.g., a low beam distribution pattern). The size, material and refractive index of the aspherical surface 110 are not limited to a particular size, material and refractive index provided that the aspherical surface 110 may project light that may be irridated from the first light source 200 or reflected by the reflector 300. The flange 120 will be described in further detail below.

The first light source 200 may be positioned behind (e.g., distal to) a focus of the aspherical surface 110. The first light source 200 may be installed on an upper surface of a support plate and may emit light in an upward direction or on a lower surface of the support plate and may emit light in a downward direction. The first light source 200 may be a light-emitting diode (LED), a bulb, etc. For example, the LED may be a semiconductor device that may convert an electric current directly into light using the phenomenon that a forward voltage applied using a p-n junction of a semiconductor thereby causing electrons in an n region to recombine with holes in a p region, thus emitting light. Typically, a white LED that may include a single light-emitting chip of approximately 1 mm square may be used. However, it will be obvious to those of ordinary skill in the art that the LED is not limited to the white LED.

The first light source 200 may also include a high-luminance LED or a multi-chip LED package. Therefore, a greater amount of light may be obtained than when utilizing a conventional LED. The type and installation form of the first light source 200 maybe any type and installation form that may be easily adoptable by those of ordinary skill in the art to which the exemplary embodiment pertains.

The reflector 300 may be placed above or below (e.g., longitudinally higher than or lower than) the first light source 200 and may be shaped having a free curved surface having an open surface to thereby reflect light that may be emitted from the first light source 200. The first light source 200 may be disposed at a first focus of the reflector 300. In an exemplary embodiment, the reflector 300 may be disposed above or below (e.g., longitudinally higher than or lower than) the first light source 200. For example, not only may the entire reflector 300 be disposed above or below the first light source 200 but also that portion of the reflector 300 is disposed above or below the first light source 200.

As shown in FIG. 3 the first light source 200 may disposed on the upper surface of the support plate, and the reflector 300 may be disposed above the first light source 200. However, this is merely an exemplary embodiment, and the first light source 200 and the reflector 300 may be placed at various positions as long as light generated by the first light source 200 may transmit through the aspherical surface 110.

The second light source 400 may be a laser diode that may generate laser light toward the flange 120. The second light source 400 may be made mainly of a nitride semiconductor that may generate laser light of various color regions that may range from, an ultraviolet (UV) region to a blue region. The second light source 400 may generate laser light of various colors according to wavelengths of light to be generated. For example, the second light source 400 may generate not only blue laser light having a peak wavelength in a wavelength range of approximately 440 to 490 nm but also laser light of various colors according to wavelengths. The flange 120 may include the entire region of the lens 100 excluding the aspherical surface 110. In the vehicle lamp 10 according to the current exemplary embodiment, the flange 120 may be a region integrally coupled (e.g., connected to) to the rear portion of the aspherical surface 110.

Referring to FIG. 4, laser light may pass through air without impurities after being emitted from the second light source 400 cannot be visually recognized. However, in a case where a medium 125 may cause scattering (e.g., dispersion) exists on an optical path L, the optical path L of the laser light passing through the medium 125 may be visually recognized. Therefore, the flange 120 may be made of a material having a scattering center (e.g., dispersion properties), so that an optical path of laser light may pass through the flange 120 and may be visually recognized. For example, the material having the scattering center may include glass, polycarbonate (PC), polymethyl methacrylate (PMMA), and acrylic. However, the material of the flange 120 is not limited to the above examples provided that laser light travelling along a predetermined path within the flange 120 may be visually recognized.

The reflective member 500 may be positioned on the flange 120 and may form an optical image by reflecting laser light that may be generated from the second light source 400 such that the laser light travels along a defined (e.g., predetermined) path. For example, the reflective member 500 may be provided on the interior or exterior of the flange 120. The reflective member 500 may be formed by coating or depositing a highly reflective material such as aluminum, chrome or a chrome alloy. The reflective member 500 may improve the efficiency of laser light. Additionally, the reflective member 500 may be have the shape of a free curved surface or an oval curved surface to reflect laser light incident from the second light source 400 such that the laser light may travel along a defined (e.g., predetermined) path. In particular, the laser light travelling along the defined (e.g., predetermined) path may form an optical image that may be distinguished from those of other vehicles.

As illustrated in FIG. 5, the reflective member 500 may transmit external light and reflect only internally reflected laser light to cause light generated by the second light source 400 to enter the flange 120. Additionally, the reflective member 500 may be formed regions in addition to a region of the flange 120 upon which laser light may be incident. In other words, the position or size of the reflective member 500 may not be limited to a particular position or size provided that the reflective member 500 may allow light generated by the second light source 400 to enter the flange 120 and form an optical image after travelling along a defined (e.g., predetermined) path.

Referring to FIGS. 2 and 5, the second light source 400 may be positioned (e.g., located) on a side of the flange 120 and may emit laser light in the direction of the flange 120 perpendicular to the optical axis C of the aspherical surface 110. Since the second light source 400 and the reflective member 500 are positioned in a common plane perpendicular to the optical axis C of the aspherical surface 110, the optical path of the laser light may be formed in the plane perpendicular to the optical axis C. Therefore, the laser light may be obstructed from reaching the visual field of a pedestrian proximate to the vehicle after being irradiated to the exterior of the vehicle. The above configuration is an exemplary embodiment, and the position of the second light source 400 with respect to the flange 120, the irradiation angle of laser light, etc. may be varied. Additionally, the reflective member 500 may include a plurality of reflective regions having predetermined reflectivity.

For example, referring to FIG. 5, laser light incident upon the flange 120 may be reflected (e.g., sequentially) by reflective regions of the reflective member 500 which may be positioned on a lower right side, an upper right side, an upper left side and a lower left side of the flange 120 and may form an optical image having the illuminance of the reflected laser light that may be reduced at varying rates. Alternatively, the reflective member 500 may include a plurality of reflective regions that may have the same reflectivity such that the illuminance of reflected laser light may be reduced at a constant rate according to the number of reflections.

For example, referring to FIG. 5, laser light incident upon the flange 120 may be reflected (e.g., sequentially) by the reflective regions of the reflective member 500 which may be positioned on the lower right side, the upper right side, the upper left side and the lower left side of the flange 120 and may form an optical image having the illuminance of the reflected laser light reduced at a constant rate. Therefore, a gradation effect may be determined by the operator of the vehicle. As a result, an optical image may be formed that may be distinguished from the optical images of other vehicles.

The number of reflective regions that may be included in the reflective member 500 may not be limited to a particular number provided that the reflective member 500 may form an optical image by reflecting laser light such that the laser light may travel along a defined (e.g., predetermined) path. Additionally, various rates may be applicable to the different rates or the constant rate as long as the gradation effect may be brought about. Furthermore, the reflective member 500 may reflect laser light such that a predetermined path of the laser light for creating an optical image may form an infinite loop.

For example, referring to FIGS. 5 through 7, the laser light incident from the second light source 400 onto the flange 120 may be reflected (e.g., sequentially) by the reflective regions positioned on the lower right side, the upper right side and the upper left side of the flange 120 to travel along a defined (e.g., predetermined) rectangular path. The laser light that travelled along the defined (e.g., predetermined) rectangular path may be reflected by the reflective region positioned on the lower left side. Furthermore, the laser light may be (e.g., sequentially) reflected by the reflective regions positioned on the lower right side, the upper right side and the upper left side to repeatedly travel along the rectangular path. In other words, the laser light may travel along a path that may form an infinite loop. Therefore, laser light travelling along an optical path that forms an infinite loop may form an optical image with similar overall illuminance, thereby providing a stable optical image.

In particular, as long as the vehicle lamp 10 may be recognized by a pedestrian as an optical image having similar overall illuminance, the detailed configuration of the reflective member 500 that may enable a defined (e.g., predetermined) path of laser light to form an infinite loop may be any configuration applicable by those of ordinary skill in the art to which the exemplary embodiments pertain.

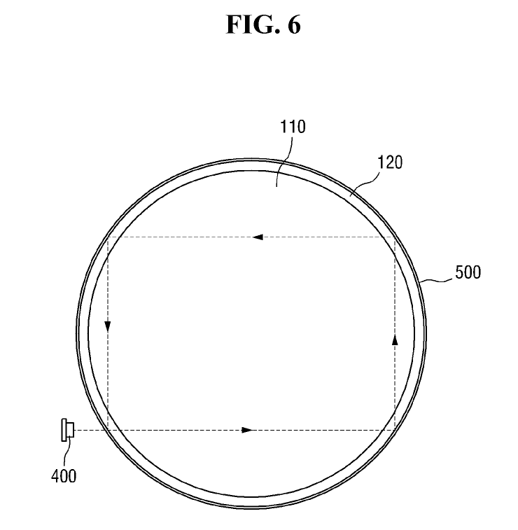

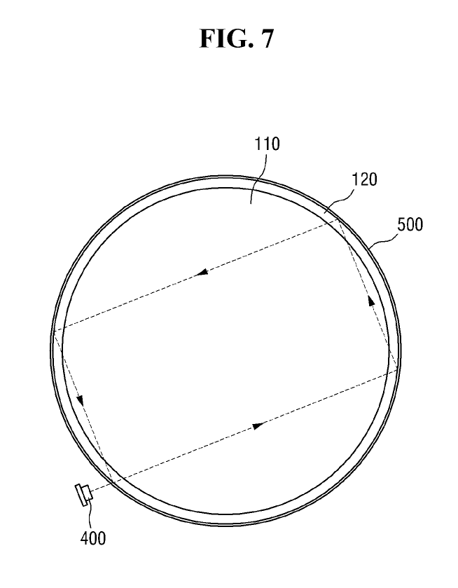

Additionally, the reflective member 500 may be formed on particular regions of the flange 120 as illustrated in FIGS. 2 and 5 or on the entire circumferential surface of the flange 120 as illustrated in FIGS. 6 and 7. For example, a defined (e.g., predetermined) path along which laser light travels may vary according to an angle at which the laser light may be incident upon the flange 120. In other words, when laser light may be incident upon the flange 120 parallel to an X axis as illustrated in FIG. 6, a defined (e.g., predetermined) path along which the laser light travels may form a rectangular shape parallel to the X axis. Alternatively, when laser light may be incident upon the flange 120 at a predetermined angle to the X axis, a defined (e.g., predetermined) path along which the laser light travels may form a rectangular shape tilted at the predetermined angle to the X axis.

Therefore, various optical images may be formed according to angles at which laser light may be incident from the second light source 400 onto the flange 120. In particular, when the reflective member 500 may be formed on the entire circumferential surface of the flange 120, the reflective member 500 may be formed on the whole of an exposed surface of the flange 120, excluding a region upon which laser light may be incident from the second light source 400. However, this is merely an exemplary embodiment, and a region of the flange 120 on which the reflective member 500 is formed may be changed or varied.

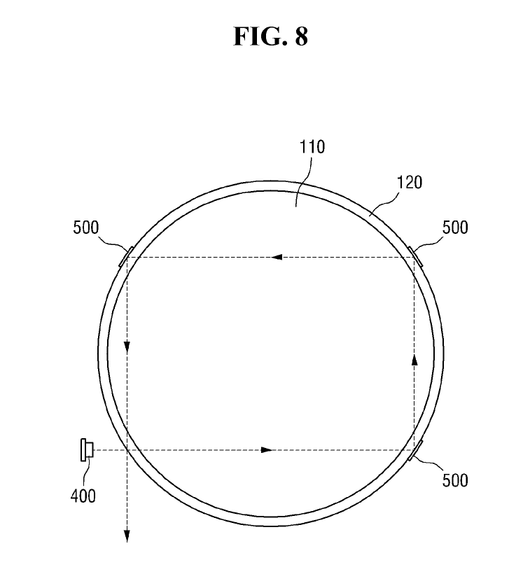

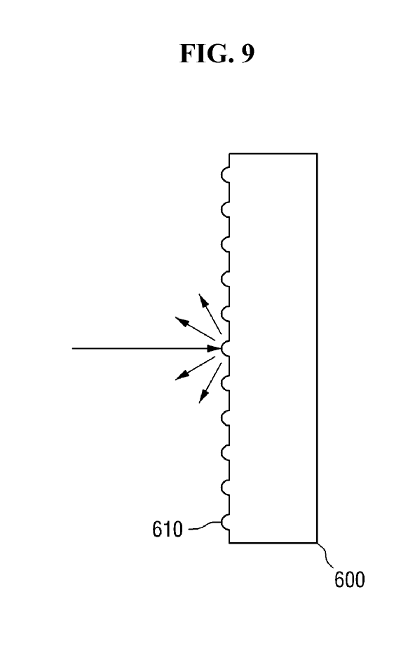

FIG. 8 is an exemplary front view of the vehicle lamp 10 of FIG. 2. FIG. 9 is an exemplary schematic view of a light-blocking member 600 according to an exemplary embodiment of the present invention. Referring to FIG. 8, the reflective member 500 may reflect laser light, which travelled along a defined (e.g., predetermined) path, to the exterior of the lens 100. Since laser light that formed an optical image after traveling along a defined (e.g., predetermined) path may be reflected toward the exterior of the lens 100, it may be obstructed from travelling beyond the boundaries of the defined (e.g., predetermined) path. As a result, an optical image having an illuminance level and shape desired by a user may be formed. For example, a light guide member including a light guide or an optic fiber may further be provided. The light guide member may guide light reflected to the exterior of the lens 100 to a region that is not visible from the exterior a vehicle.

Additionally, the vehicle lamp 10 according to the current exemplary embodiment may further include the light-blocking (e.g., obstructing) member 600 having a pattern that scatters (e.g., disperses) light reflected out of the lens 100. For example, referring to FIG. 9, laser light reflected out (e.g., to the exterior) of the lens 100 may be scattered (e.g., dispersed) in various directions by a plurality of protrusions 610 that may be formed on the light-blocking (e.g., obstructing) member 600 to be offset. Therefore, the light guide or the light guide member or the light-blocking member 600 may prevent laser light propagating toward the exterior of the vehicle from reaching the field of vision of a pedestrian.

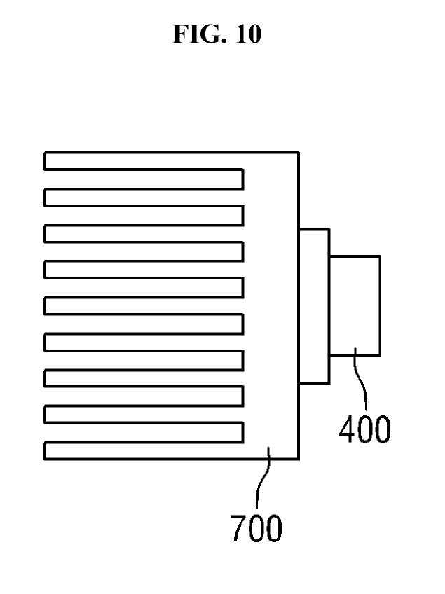

FIG. 10 is an exemplary schematic view of the second light source 400 and a heat sink 700 according to an exemplary embodiment. Referring to FIG. 10, the vehicle lamp 10 of FIG. 2 may include the heat sink 700 which may be coupled to the second light source 400 and may dissipate the heat generated by the second light source 400. The performance of a laser diode may vary according to temperature variations. Therefore, when a laser diode may be used as the second light source 400, the intensity of laser light generated by the second light source 400 may vary according to a change in the temperature surrounding the vehicle lamp 10 even when applying an electric current of the same magnitude. In other words, in order to maintain a constant intensity of laser light generated by the second light source 400, the temperature surrounding the vehicle lamp 10 is required to be maintained constant by dissipating heat generated from the second light source 400.

Further, the heat sink 700 may be coupled the second light source 400 and may also be coupled to the first light source 200 or the lens 100 in order to reduce the deterioration of characteristics or deformation of the first light source 200 or the lens 100. In an exemplary embodiment, the heat sink 700 may be made of a material having relatively high thermal conductivity, such as magnesium (Mg) or aluminum (Al). However, the material of the heat sink 700 is not limited to the above exemplary embodiments and various materials having superior thermal conductivity such as a nonferrous metal material and thermally conductive plastic may also be used.

Additionally, a plurality of heat dissipating fins may be positioned on at least any one surface of the heat sink 700 to increase the heat dissipation area. The detailed configuration of the heat sink 700 coupled to the first light source 200, the second light source 400 and/or the lens 100 may be changed provided the performance of the first and second light sources 200 and 400 and the shape of the lens 100 may be maintained.

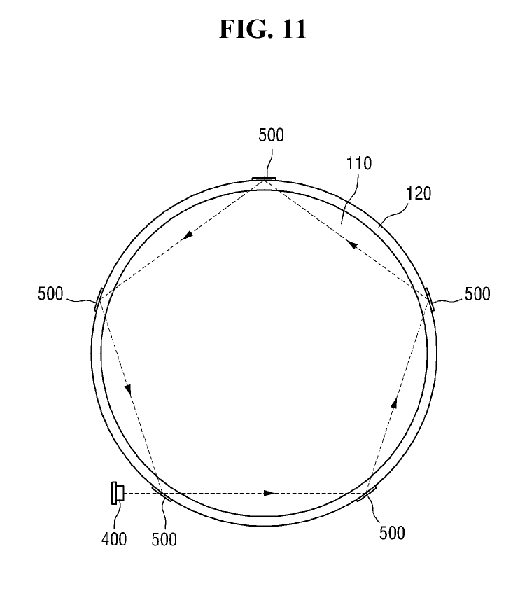

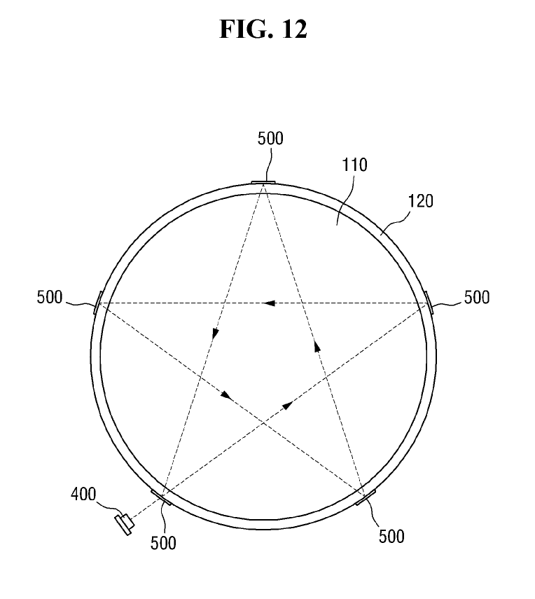

Hereinafter, the geometric shapes of an optical image formed by the vehicle lamp 10 of FIG. 2 will be described. FIGS. 11 and 12 are exemplary front views of the vehicle lamp 10 of FIG. 2. An optical image formed by a path along which laser light travels in the vehicle lamp 10 of FIG. 2 may have a polygonal shape or an overlap of polygonal shapes. For example, a rectangular optical image may be formed as illustrated in FIG. 5, a pentagonal optical image may be formed as illustrated in FIG. 11, and a star-shaped optical image composed of one pentagon and five triangles overlapping each other may be formed as illustrated in FIG. 12.

The above geometric shapes are merely some examples of an optical image formed by the vehicle lamp 10 of FIG. 2, and an optical image having various shapes may be formed through design modifications. Additionally, the vehicle lamp 10 of FIG. 2 may form a positioning beam pattern through an optical image formed in the flange 120 by laser light travelling along a defined (e.g., predetermined) path. Therefore, a positioning function may be implemented by driving only the second light source 400 regardless of whether the first light source 200 positioned behind (e.g., distal to) the aspherical surface 110 may be engaged in the on or off positions. In particular, the positioning function may be a function that is turned on even in the daytime in order to enhance a vehicle's safety performance and inform other vehicles of the vehicle's driving state.

The detailed configuration of each of the flange 120 and the reflective member 500 for forming a positioning beam pattern through an optical image may include any configuration applicable by those of ordinary skill in the art to which the present exemplary embodiment pertains. Therefore, the vehicle lamp 10 of FIG. 2 may form an optical image of various geometric shapes that may be distinguished from those of other vehicles, thereby improving recognition of a particular manufacturer's products. Additionally, laser light may be prevented from reaching the field of vision of a pedestrian proximate to the vehicle after being irradiated to the exterior of the vehicle.

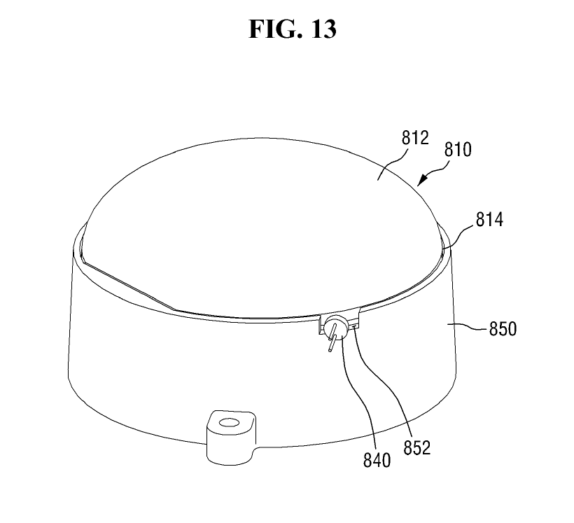

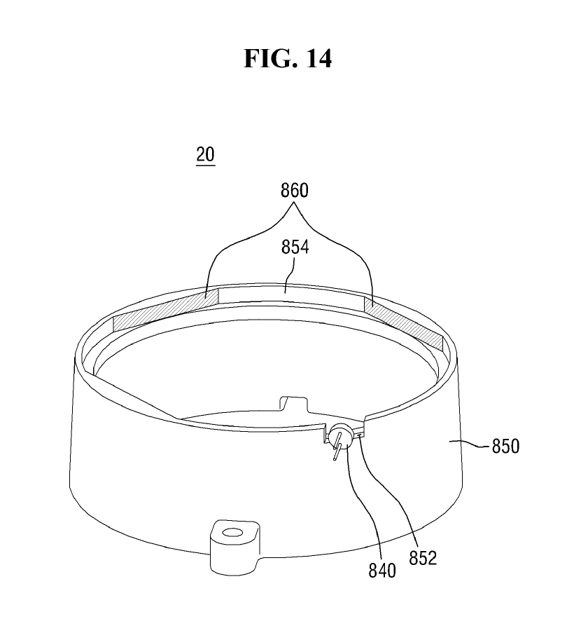

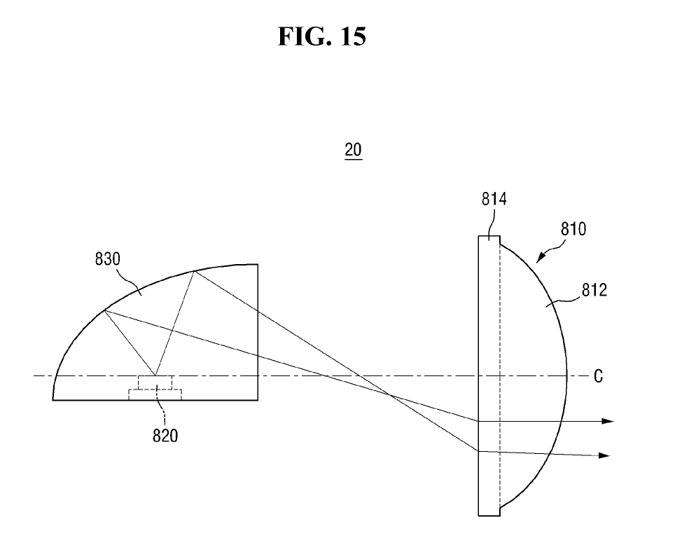

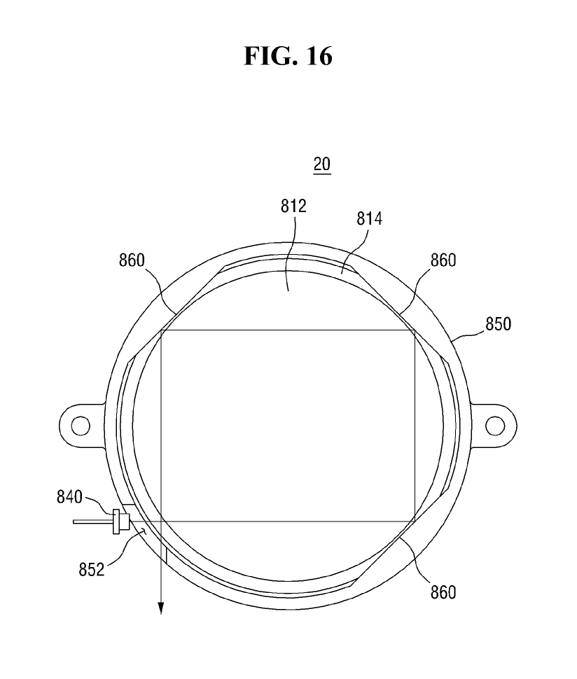

FIG. 13 is an exemplary perspective view of a vehicle lamp 20 according to another exemplary embodiment. FIG. 14 is an exemplary perspective view of a second light source 840, a lens holder 850, and a reflective member 860 according to another exemplary embodiment. Additionally, FIG. 15 is an exemplary lateral view of the vehicle lamp 20 of FIG. 13. FIG. 16 is an exemplary front view of the vehicle lamp 20 of FIG. 13. Referring to FIGS. 13 through 16, the vehicle lamp 20 according to the exemplary embodiment may include a lens 810, a first light source 820, a reflector 830, the second light source 840, the lens holder 850 and the reflective member 860 but does not preclude the addition of other components.

The lens 810, the first light source 820, the reflector 830 and the second light source 840 of the vehicle lamp 20 according to the exemplary embodiment may be, but are not limited to, the same as the lens 100, the first light source 200, the reflector 300 and the second light source 400 of the vehicle lamp 10 according to the previous exemplary embodiment. The lens holder 850 may be structured to have an empty space (e.g., cavity) therein such that light generated within the vehicle lamp 20 may be distributed out of the vehicle lamp 20 through an aspherical surface 812. The lens holder 850 may be coupled to a flange 814 to support the lens 810. In particular, the lens holder 850 may be configured to (e.g., adhered or screw-coupled) to the flange 814. For example, any method by which those of ordinary skill in the art may couple the lens holder 850 to the flange 814 may be used. Provided that the lens holder 850 may support the lens 810, the coupling position, method, etc. of the lens holder 850 to the flange 814 are not limited to a particular position, method, etc.

Additionally, the lens holder 850 may include an incident region 852 to which laser light generated by the second light source 840 may be input. The incident region 852 may allow laser light generated by the second light source 840 to enter the flange 814 via the lens holder 850. The size of the incident region 852 may not be limited to a particular size provided that the light generated by the second light source 840 may enter the flange 814.

The reflective member 860 may be positioned on the interior of the lens holder 850 which may interface with (e.g., meet, connect to) the flange 814. The reflective member 860 may reflect laser light incident upon the flange 814 such that the laser light may travel along a defined (e.g., predetermined) path to form an optical image disposed on the flange 814. In particular, the reflective member 860 provided on the interior of the lens holder 850 may be formed by coating or depositing a highly reflective material such as aluminum, chrome or a chrome alloy. The reflective member 860 may improve the efficiency of laser light.

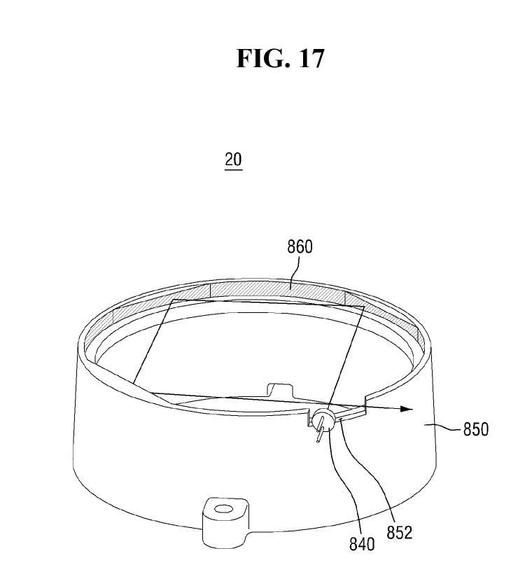

To reflect laser light incident from the second light source 840 such that the laser light may travel along a defined (e.g., predetermined) path, the reflective member 860 may be shaped in a straight line as illustrated in FIGS. 13 and 14 or having a free curved surface or an oval curved surface as illustrated in FIG. 17. Additionally, the second light source 840 may be positioned on a side of the incident region 852 and irradiate laser light in the direction of the incident region 852 and the flange 814 perpendicular to an optical axis C. In other words, since the second light source 840 and the reflective member 860 may be positioned in a common plane perpendicular to the optical axis C of the aspherical surface 812, the optical path of the laser light may be formed in the plane perpendicular to the optical axis C. Therefore, the laser light may be prevented from reaching the field of visions of a pedestrian proximate to a vehicle after being irradiated to the exterior of the vehicle. The above configuration according to the exemplary embodiment of the present invention, however the position of the second light source 840 with respect to the incident region 852 or the flange 814, the irradiation angle of laser light, etc. may be varied.

Additionally, the reflective member 860 may include a plurality of reflective regions having defined (e.g., predetermined) reflectivity. For example, referring to FIG. 16, laser light incident upon the flange 814 may be reflected (e.g., sequentially) by reflective regions of the reflective member 860 which are positioned on a lower right side, an upper right side and an upper left side of the lens holder 850 to form an optical image having the illuminance of the reflected laser light that may be reduced at varying rates. Otherwise, the reflective member 860 may include a plurality of reflective regions having the same reflectivity such that the illuminance of reflected laser light may be reduced at a constant rate according to the number of reflections.

For example, referring to FIG. 16, laser light incident upon the flange 120 may be reflected (e.g., sequentially) by the reflective regions of the reflective member 860 that may be positioned on the lower right side, the upper right side, and the upper left side of the lens holder 850 to form an optical image having the illuminance of the reflected laser light reduced at a constant rate. Therefore, a gradation effect may be brought about to the extent desired by a user. As a result, an optical image that may be distinguished from those of other vehicles may be formed.

The number of reflective regions included in the reflective member 860 may not be limited to a particular number as long as the reflective member 860 may form an optical image by reflecting laser light such that the laser light travels along a defined (e.g, predetermined) path. Additionally, various rates may be applicable to the different rates or the constant rate as long as the gradation effect may be brought about.

FIG. 17 is an exemplary perspective view of the vehicle lamp 20 of FIG. 13. Referring to FIG. 17, the reflective member 860 may be formed on the entire interior 854 of the lens holder 850 that connects (e.g., meets or is coupled to) the flange 814. In particular, a defined (e.g., predetermined) path along which laser light travels may vary according to an angle at which the laser light may be incident from the second light source 840 onto the incident region 852. For example, laser light may be incident upon the incident region 852 parallel to an X axis as illustrated in FIGS. 16 and 17, a predetermined path along which the laser light travels may form a rectangular shape parallel to the X axis. Alternatively, laser light may be incident upon the incident region 852 at a predetermined angle to the X axis, a predetermined path along which the laser light travels may form a rectangular shape tilted at the predetermined angle to the X axis. Therefore, various optical images may be formed according to angles at which laser light may be incident from the second light source 840 onto the flange 814.

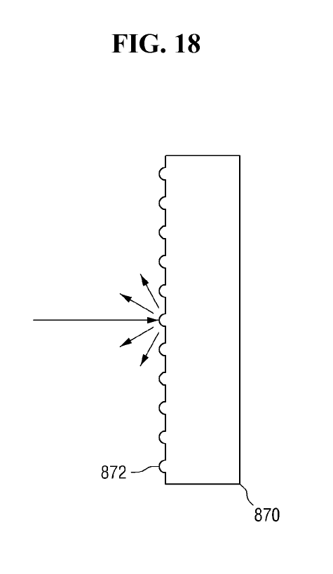

FIG. 18 is an exemplary schematic view of a light-blocking (e.g., obstructing) member 870 according to another exemplary embodiment. Referring to FIG. 18, the reflective member 860 may reflect laser light, that may along a defined (e.g., predetermined) path, to the exterior of the lens 810. The laser light that formed an optical image after traveling along a defined (e.g., predetermined) path may be reflected to the exterior of the lens 810, it may be prevented from travelling outside the defined (e.g., predetermined) path. Accordingly, an optical image having an illuminance level and geometric shape desired by a user may be formed. For example, a light guide member such as a light guide or an optic fiber may be further provided. The light guide member may guide light reflected to the exterior of the lens 810 to a region not visible from the exterior of the vehicle. Additionally, the vehicle lamp 20 according to the exemplary embodiment may further include the light-blocking (e.g., obstructing) member 870 that may include a pattern that scatters (e.g., disperses) light reflected to the exterior of the lens 810.

For example, referring to FIG. 18, laser light reflected to the exterior of the lens 810 may be scattered (e.g., dispersed) in various directions by a plurality of protrusions 872 formed on the light-blocking (e.g., obstructing) member 870 to be offset. Therefore, the light guide or the light guide member or the light-blocking member 870 may prevent laser light propagating to the exterior of the vehicle from reaching the field of vision of a pedestrian.

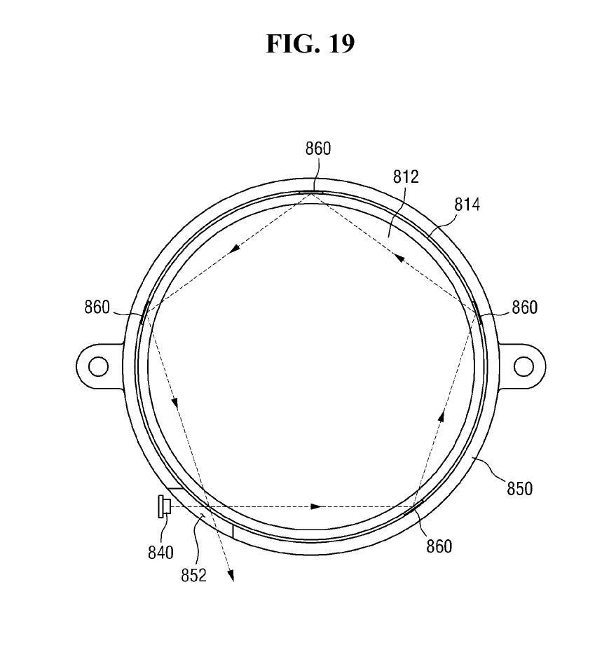

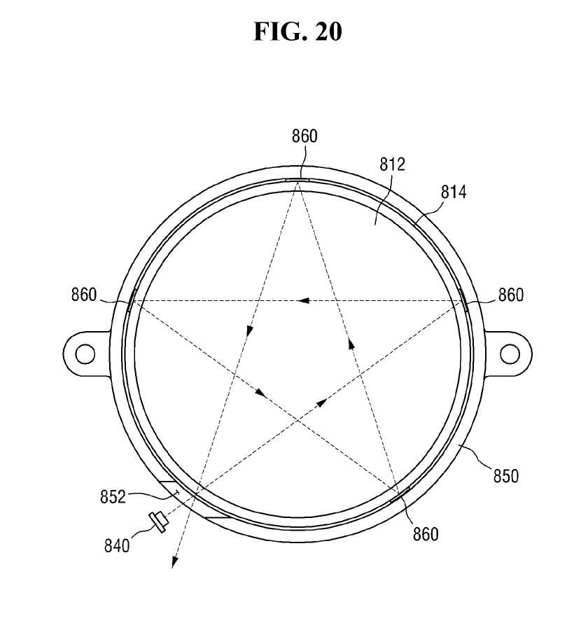

Hereinafter, the geometric shapes of an optical image formed by the vehicle lamp 20 of FIG. 13 will be described. FIGS. 19 and 20 are exemplary front views of the vehicle lamp 20 of FIG. 13. An optical image formed by a path along which laser light travels in the vehicle lamp 20 of FIG. 13 may have a polygonal shape or an overlap of polygonal shapes. For example, a rectangular optical image may be formed as illustrated in FIG. 16, a pentagonal optical image may be formed as illustrated in FIG. 19, and a star-shaped optical image composed of one pentagon and five triangles overlapping each other can be formed as illustrated in FIG. 20.

The above shapes are merely examples of an optical image formed by the vehicle lamp 20 of FIG. 13, and an optical image having various shapes may be formed through design modifications. The detailed configuration of the vehicle lamp 20 not described herein may be the same as the detailed configuration of the vehicle lamp 10 according to the previous exemplary embodiment. However, the present invention is not limited thereto, and various modifications may be made to the detailed configuration of the vehicle lamp 20. Therefore, the vehicle lamp 20 according to the exemplary embodiment can form an optical image of various shapes distinguished from those of other vehicles, thereby improving recognition of a particular manufacturer's products. In addition, laser light can be prevented from reaching the field of vision of a pedestrian proximate to the vehicle after being irradiated to the exterior of the vehicle.

Exemplary embodiments provide at least one of the following advantages. According to the exemplary embodiments, an optical image distinguished from those of other vehicles may be formed using laser light. However, the effects of the exemplary embodiments are not restricted to the one set forth herein.

The invention has been described in connection with what is presently considered to be exemplary embodiments, but on the contrary, is intended to cover various modifications and equivalent arrangements included within the sprit and scope of the appended claims. In addition, it is to be considered that all of these modifications and alterations fall within the scope of the present invention.

What is claimed is:

1. A vehicle lamp comprising:
a lens including an aspherical surface disposed on an optical axis extending along a lengthwise direction of a vehicle and a flange coupled to a rear portion of the aspherical surface;
a first light source disposed behind a focus of the aspherical surface;
a reflector which reflects light of the first light source toward the aspherical surface;
a second light source which generates laser light toward the flange; and
a reflective member positioned on the flange and forms an optical image by reflecting the laser light such that the laser light travels along a defined path.

2. The vehicle lamp of claim 1, wherein the second light source is positioned on a side of the flange and irradiates the laser light toward the flange perpendicular to the optical axis.

3. The vehicle lamp of claim 1, wherein the reflective member is formed by coating or depositing a reflective material.

4. The vehicle lamp of claim 1, wherein the reflective member is formed on the entre circumferential surface of the flange, and the defined path along which the laser light travels varies according to an angle at which the laser light is incident from the second light source onto the flange.

5. The vehicle lamp of claim 1, wherein the reflective member reflects the laser light, which travelled along the defined path, to an exterior of the lens.

6. The vehicle lamp of claim 5, further comprising a light-blocking member having a pattern which scatters the laser light reflected to the exterior of the lens.

7. The vehicle lamp of claim 1, wherein the reflective member comprises a plurality of reflective regions having predetermined reflectivity.

8. The vehicle lamp of claim 7, wherein the reflective member includes a plurality of reflective regions having a similar reflectivity such that illuminance of reflected laser light is reduced at a constant rate according to the number of reflections.

9. The vehicle lamp of claim 1, wherein the reflective member reflects the laser light such that the defined path forms an infinite loop.

10. The vehicle lamp of claim 1, wherein the optical image has a polygonal shape or an overlap of polygonal shapes.

11. The vehicle lamp of claim 1, wherein the flange forms a positioning beam pattern through the optical image.

12. The vehicle lamp of claim 1, further comprising a heat sink which is coupled to the second light source and dissipates heat generated by the second light source.

13. A vehicle lamp comprising:
a lens having an aspherical surface positioned on an optical axis extending in a lengthwise direction of a vehicle and a flange coupled to a rear portion of the aspherical surface;
a first light source disposed behind a focus of the aspherical surface;
a reflector which reflects light of the first light source toward the aspherical surface;
a second light source which generates laser light;
a lens holder including an incident region upon which the laser light is incident and is coupled to the flange to fix the lens; and
a reflective member positioned on the interior of the lens holder which interfaces with the flange and forms an optical image by reflecting the incident laser light such that the laser light travels along a defined path on the flange.

14. The vehicle lamp of claim 13, wherein the second light source is positioned on a side of the incident region and irradiates the laser light toward the incident region perpendicular to the optical axis.

15. The vehicle lamp of claim 13, wherein the reflective member is formed by coating or depositing a reflective material.

16. The vehicle lamp of claim 13, wherein the reflective member is formed on the entre interior of the lens holder which interfaces with the flange, and the predetermined path along which the laser light travels varies according to an angle at which the laser light is incident from the second light source onto the incident region.

17. The vehicle lamp of claim 13, wherein the reflective member reflects the laser light that travelled along the defined path, out of the lens.

18. The vehicle lamp of claim 13, further comprising a light-blocking member having a pattern which scatters the laser light reflected out of the lens.

19. The vehicle lamp of claim 13, wherein the reflective member includes a plurality of reflective regions having the same reflectivity such that illuminance of reflected laser light is reduced at a constant rate according to the number of reflections.

20. The vehicle lamp of claim 13, wherein the optical image has a polygonal shape or an overlap of polygonal shapes.
